(19) United States
(12) Patent Application Publication
(10) Pub. No.: US 2010/0142916 A1
(43) Pub. Date: Jun. 10, 2010

(54) Content reproducing device

(75) Inventor: Tetsuya Hirano, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/588,292

(22) Filed: Oct. 9, 2009

(30) Foreign Application Priority Data
Dec. 10, 2008 (JP) 2008-313907

(51) Int. Cl. H04N 5/91

(52) U.S. Cl. 386/68; 386/E05.003

(57) ABSTRACT

A content reproducing device 1 reproducing a video/audio content recorded on a recording medium accesses the recording medium as triggered by a predetermined user's operation before a start of reproducing the content, generates a table from reproducing sequence information of respective control information files, determines the content file to be reproduced next from a relationship between the content file reproducing sequence indicated in the table and an operation count of a skipping operation, and reproduces the content file.

### CROSS-REFERENCE TO RELATED APPLICATIONS

This application is based upon and claims the benefit of priority of the prior Japanese Patent Application No. JP2008-313907, filed on Dec. 10, 2008, the entire contents of which are incorporated herein by reference.

### FIELD

The present invention relates to a content reproducing device.

### BACKGROUND

Over the recent years, with developments of information technologies, a technology of reproducing a recording medium recorded with information has become highly sophisticated. For example, a disc player for playing back an optical disc recorded with a content of a movie etc is provided with a function capable of moving a playback position of the content recorded on the disc on a segment-by-segment basis such as a chapter and a track. This function enables a user to select an arbitrary playback position by operating a button.

For example, Patent document 1 discloses a technology of storing an operation count of a skip-up key till a read of management information on a recording medium is completed, and, when completing the read of the management information, reproducing this read-completed area. Further, Patent document 2 discloses a technology enabling a user's operation such as skip-up and skip-down which are inhibited from being operated during the reproduction (playback) without any violation of DVD standards. Yet further, Patent document 3 discloses a technology of displaying a title-and-chapter layout in a rectangular shape, in which the title and the chapter are recorded on the optical disc. Still further, Patent document 4 discloses a technology which facilitates setting of a title and a chapter to be reproduced.

[Patent document 1] Japanese Patent Laid-Open Publication No. 2000-90650

[Patent document 2] Japanese Patent Laid-Open Publication No. 2006-338833

[Patent document 3] Japanese Patent Laid-Open Publication No. 2005-92994

[Patent document 4] Japanese Patent Laid-Open Publication No. H11-66826

### SUMMARY

The skipping operation over the chapter and the track, which is performed on a reproducing device for reproducing (playing back) a video/audio content, is consecutively conducted till a desired reproducing position (playback position) is selected. Hence, it is desirable in terms of operability that a response characteristic to the consecutive operations such as this is excellent. Especially in the case of an on-vehicle reproducing device, a user riding in a car often operates the reproducing device while performing some kind of action. Therefore, in the on-vehicle reproducing device, the skipping operation over the chapter and the track is consecutively conducted often in particular in such a way that the user does not confirm the response to the operation from the reproducing device.

Herein, there is no restraint to movement of the playback position across the tracks arranged in sequence as on a CD (Compact disc), in which case the characteristic of response to the operation can be ameliorated by omitting a time-consuming access to the disc in a way that accepts and processes the consecutive skipping operations within a range that does not exceed a total number of tracks.

On the other hand, control information such as an intra-disc chapter reproducing sequence and permissibility of the user's operation is registered according to an intention of a disc manufacturer on an optical disc such as a DVD and Blu-ray Disc (registered trademark) which deal with video contents. Hence, it follows that the skipping operation conforms to the control information such as this. Herein, in the case of performing the consecutive skipping operations, if the operation is only accepted and processed simply within the range that does not exceed the total number of chapters, there is a possibility that the chapters are not played back according to the sequence specified by the control information and that an inhibited skipping operation might be permitted. In the case of acquiring the control information of every chapter each time the skipping operation is conducted, a hardware-based physical access to the disc is required, and hence the characteristic of response to the consecutive skipping operations extremely declines. It is an object of the present invention, which was devised in view of such problems, to provide a content reproducing device having an excellent characteristic of response on the occasion of performing the skipping operation in a process of reproducing plural categories of content data within a recording medium with an already-specified reproducing sequence.

According to the present invention, in order to solve the problems given above, a table is generated from reproducing sequence information recorded on a recording medium, and a user's operation is processed based on this table.

Specifically, a content reproducing device reproducing a video/audio content recorded on a recording medium, includes: a reproduction processing unit accessing the recording medium and reproducing a plurality of content files stored with content reproducing data sequentially on the basis of a table indicating a content file reproducing sequence; a table generating unit referring to a plurality of control information files prepared on a per-content-file basis within the recording medium and each having information, as reproduction sequence information, about the content file to be reproduced next to a self-corresponding content file, and thus generating the table from the reproduction sequence information of the respective control information files; and an operation processing unit accepting a user's skipping operation over an in-reproduction content file, wherein the operation processing unit, when accepting the skipping operation, determines the content file to be reproduced next from a relationship between the content file reproducing sequence indicated in the table generated by the table generating unit and the operation count of the skipping operation, and the reproduction processing unit, when the operation processing unit determines the content file to be reproduced next, accesses the recording medium and reproduces the content file determined to be reproduced by the operation processing unit.

The content reproducing device accesses the recording medium with contents stored in the plurality of files and sequentially reads the content reproducing data. Then, the reproduction processing unit reproduces this data. At this time, the reproducing sequence of the content files reproduced by the reproduction processing unit is defined in a plurality of control information files recorded on the recording medium. The reproduction processing unit sequentially reproduces the respective content files in the sequence conforming to the reproducing sequence information defined in each control information file.

Herein, in the content reproducing device, the reproducing sequence information is extracted by referring to the respective control information files recorded on the recording medium, and the table generating unit generates the table by tabularizing these items of information. Then, the operation processing unit accepting the skipping operation of the user determines the should-be-reproduced content file from the relationship between the skipping operation count and the reproducing sequence indicated in the table. With this scheme, even when the user's operation is conducted, the physical access to the control information file recorded on the recording medium is omitted, whereby the responding process to the user's operation is quickly executed. Accordingly, the characteristic of response on the occasion of performing the skipping operation is improved.

Further, the table generating unit may tabularize the reproducing sequence information given on the per-content-file basis and thus generates the table, and the operation processing unit may accept the skipping operation conforming to the content file reproducing sequence information indicated in the table, and may determine, as the content file to be reproduced next, the content file which is to be reproduced in the case of skipping by the operation count of the skipping operation. According to the thus-configured content reproducing device, such a table is generated that the items of reproducing sequence information of the respective content files are arranged in sequence. Hence, it follows that the table generating process is quickly executed, and resultantly the characteristic of response on the occasion of performing the skipping operation is improved.

Still further, the operation processing unit may, when accepting the skipping operation in the middle of generating the table by the table generating unit, access the recording medium and may determine the content file to be reproduced next from the reproducing sequence information of the control information files. The generation of the table entails referring to all of the control information files and requiring the time till the table is completed. Hence, if the skipping operation during this period of time, the reproducing sequence information of the control information files recorded on the recording medium is read, and the operating process is executed, thereby enabling the user's skipping operation to be processed quickly.

Yet further, each control information file may further contain, as operation permissibility information, on permissibility of the user's operation, the table generating unit may tabularize the reproducing sequence information and the operation permissibility information on the per-content-file basis and thus may generate the table, and the operation processing unit may, when accepting the skipping operation, determine the content file to be reproduced next on the basis of a relationship between the content file reproducing sequence indicated in the table generated by the table generating unit and the operation count of the skipping operation and on the basis of details of the operation permissibility of each content file. According to this scheme, the characteristic of response to the user's operation can be improved through the operating process based on the control information in the table, and it does not happen that the user's operation related to the forbidden items set by a content creator is executed.

Moreover, the table generating unit may, upon a trigger of a predetermined user's operation performed before a start of reproducing the content, access the recording medium and may generate the table from the reproducing sequence information of each control information file, and the predetermined user's operation may be at least any one of an operation of inserting the recording medium into the content reproducing device, an operation of reproducing the content recorded on the recording medium and an operation of switching ON a power source of the content reproducing device in an inserted status of the recording medium. If the generation of the table is started when the user's operation such as this is executed, the table is completed more quickly. Hence, such a possibility rises that the table is completed till the user performs the skipping operation, which contributes to the improvement of the characteristic of response to the user's operation.

Furthermore, the content reproducing device may further include a display unit displaying information about the content file to be reproduced next, which is determined by the operation processing unit. When the skipping operation is conducted, the information about the content file to be reproduced next is displayed, thereby enabling the user to immediately check the response to the operation through the information displayed on the display unit.

It is feasible to provide the content reproducing device having the excellent characteristic of response on the occasion of performing the skipping operation in the process of reproducing the plural categories of content data within the recording medium with the reproducing sequence being already determined.

### BRIEF DESCRIPTION OF THE DRAWINGS

FIG. 1 is a schematic diagram of a configuration of a BD player;

FIG. 1B is a diagram illustrating an example of how operation buttons are disposed;

FIG. 1C is a diagram illustrating an example of how the operation buttons are disposed;

FIG. 2 is a diagram of function blocks realized by the BD player;

FIG. 3 is a diagram of a file structure on a Blu-ray Disc;

FIG. 4 is a flowchart of a processing flow of the whole BD player;

FIG. 5 is a flowchart of a table generating process;

FIG. 6 is a diagram illustrating one example of a table generated by a table generating function unit;

FIG. 7 is a diagram illustrating an operable pattern;

FIG. 8A is a flowchart illustrating one example of an operation process in a virtual control mode;

FIG. 8B is a flowchart illustrating a process of a determinant timer;

FIG. 9 is a flowchart illustrating a processing flow when a track-up operation is conducted three times in the virtual control mode;

FIG. 10 is a flowchart illustrating a processing flow when the inhibited track-up operation is conducted in the virtual control mode;

FIG. 11 is a flowchart illustrating one example of an operation process in a real control mode; and

FIG. 12 is a diagram illustrating an outline of a flow of processes realized by the BD player.

### DESCRIPTION OF EMBODIMENTS

A best mode for carrying out the present invention will hereinafter be illustratively described. A configuration in the following embodiment is an exemplification, and the present invention is not limited to the configuration in the embodiment.

<System Architecture>

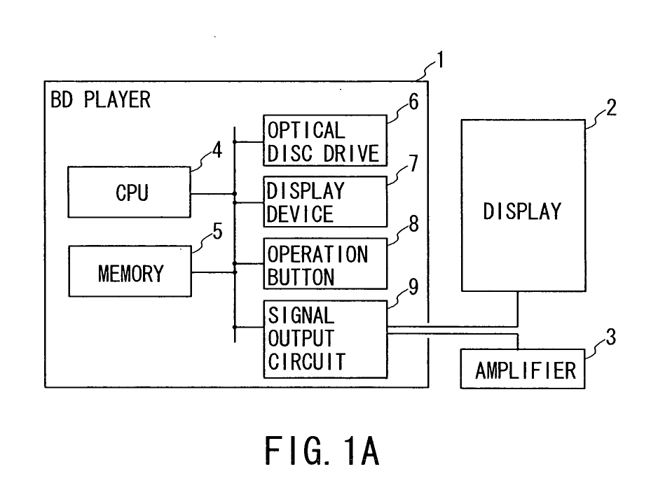

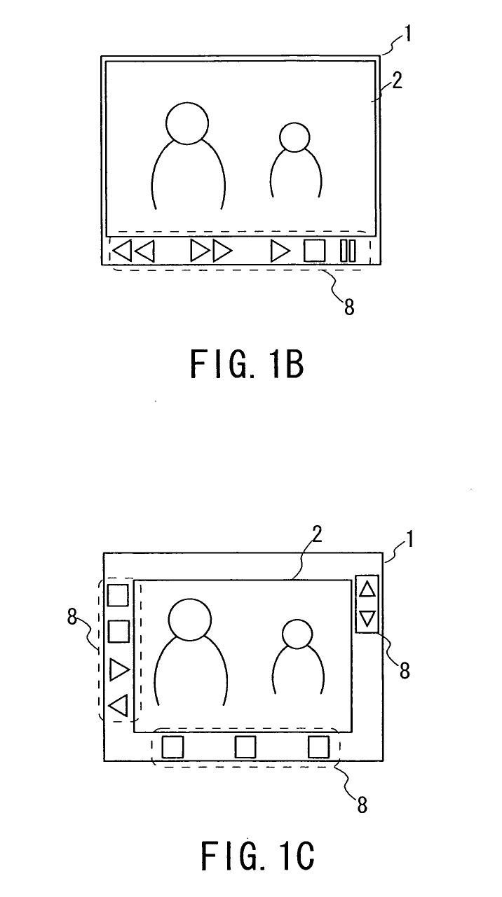

FIG. 1A is a schematic diagram illustrating a BD player 1 (“BD” is an abbreviation of Blu-ray Disc (“Blu-ray” is a registered trademark) and hereinafter represents the Blu-ray Disc) by way of one embodiment of a content reproducing device according to the present invention. The BD player 1 is an on-vehicle electronic device mounted on a vehicle such as an automobile and is connected to a display 2 defined as a liquid crystal display device and to an audio amplifier 3. The BD player 1, which connects with a power source of the vehicle, is supplied with electric power and operates when a user as a seat occupant switches ON an accessory power source by operating a key switch of the vehicle. It should be noted that the BD player 1 is described as a player in which the display 2 in charge of displaying a screen and the amplifier 3 in charge of outputting voices (sounds) are connected to the outside, however, the present invention is not limited to the embodiment such as this. Namely, the present invention may be applied to a content reproducing device having an external configuration integral with at least any one of the display and the amplifier. Moreover, the embodiment discusses the player which plays back the Blu-ray Disc, however, the present invention can be, without being limited to the embodiment such as this, applied to content reproducing devices which reproduce contents recorded on any types of recording mediums (e.g., a DVD etc) having reproducing sequences of respective chapters and tracks, which are determined according to the reproducing sequences intended by content creators.

The BD player 1 is, as depicted in FIG. 1A, constructed of a CPU (Central Processing Unit) 4, a memory 5, an optical disc drive 6, a display device 7, an operation button 8 and a signal output circuit 9.

The CPU 4 is an electronic circuit controlling the respective devices, which constitute the BD player 1, such as the optical disc drive 6, the display device 7, the operation button 8 and the signal output circuit 9 by executing a computer program recorded on the memory 5, and controlling data processing of data recorded on the optical disc. The CPU 4 builds up an environment for reading, when the user switches ON the key switch of the vehicle, a program of OS (Operating System) defined as system software recorded on the memory 5 and executing application programs for controlling the respective devices and carrying out the data processing. The memory 5 is stored with the computer program and the data of the optical disc. The memory 5 is constructed of a writable nonvolatile memory such as a flash ROM.

The optical disc drive 6 is a device capable of reading the data recorded on the optical disc such as the BD, the DVD and the CD classified as the recording mediums, and is constructed of drive mechanisms such as a spindle motor for rotating the optical disc and an actuator for actuating a pickup, an AFE (Analog Front End) for converting reflected beams of light read by the optical pickup into electric signals, a DSP (Digital Signal Processor) for converting analog signals of the AFE into digital signal, and so on. The optical disc drive 6 is controlled by the CPU 4. The memory 5 is previously stored with middleware used for the CPU 4 to execute the control of the optical disc drive 6.

The display device 7 is a liquid crystal panel provided on the side of a front surface of the BD player 1 and displays an operating status of the BD player 1. The operating status of the BD player 1, which is displayed by the display device 7, is exemplified by, e.g., an in-playback chapter number, an icon for representing that the content remains to be played back or stopped, and so forth.

The operation buttons 8 are buttons provided on the side of the front surface of the BD player 1 and accept a user's operation. Disposed as the operation buttons 8 are a playback button for playing back the optical disc, a skip button for skipping the in-playback chapter, a stop button for stopping the playback, etc. FIGS. 1B and 1C are diagrams each illustrating an example of how the operation buttons 8 are disposed in the case of configuring the BD player 1 integrally with the display 2. The operation buttons 8 can be disposed, for example, on the lower side of the display 2 as depicted in FIG. 1B or disposed on the up-and-down sides and right-and-left sides as illustrated in FIG. 1C.

The signal output circuit 9 is a circuit which outputs video data and audio data of the content played back by the optical disc drive 6 to the display 2 and the amplifier 3 each connected to the outside.

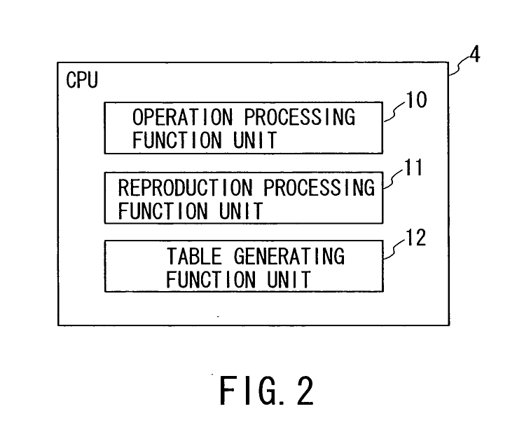

Next, function blocks realized by the BD player 1 will hereinafter be explained. FIG. 2 is a diagram illustrating the function blocks realized by the BD player 1. The power source of the BD player 1 is switched ON, and the CPU 4 executes the computer program stored on the memory 5, thereby realizing an operation processing function unit 10 (corresponding to an operation processing unit according to the present invention), a reproduction processing function unit 11 (corresponding to a reproduction processing unit according to the present invention) and a table generating function unit 12 (corresponding to a table generating unit according to the present invention) as illustrated in FIG. 2.

The operation processing function unit 10 is a function unit which controls a process mainly of the user's operation. To be specific, the operation processing function unit 10, upon detecting the user's operation on the operation button 8, controls the operations of the individual devices of the BD player 1 in cooperation with the reproduction processing function unit 11 and the table generating function unit 12 so as to actualize the operation corresponding to this user's operation.

The reproduction processing function unit 11 is a function unit which controls a process of reproducing (playing back) chiefly the content of the optical disc. Namely, the operation processing function unit 10 executes a process of regenerating the data of the content of the optical disc in the way of being triggered by the user's operation etc. Then, the regenerated video data and audio data of the content are transmitted to the signal output circuit 9.

Mainly, the table generating function unit 12 analyzes the content data stored on the optical disc and thus generates a table. The table is what the table generating function unit 12 reads and organizes the reproduction control information of a multiplicity of content files recorded on the optical disc, and is stored on the memory 5.

<File Structure>

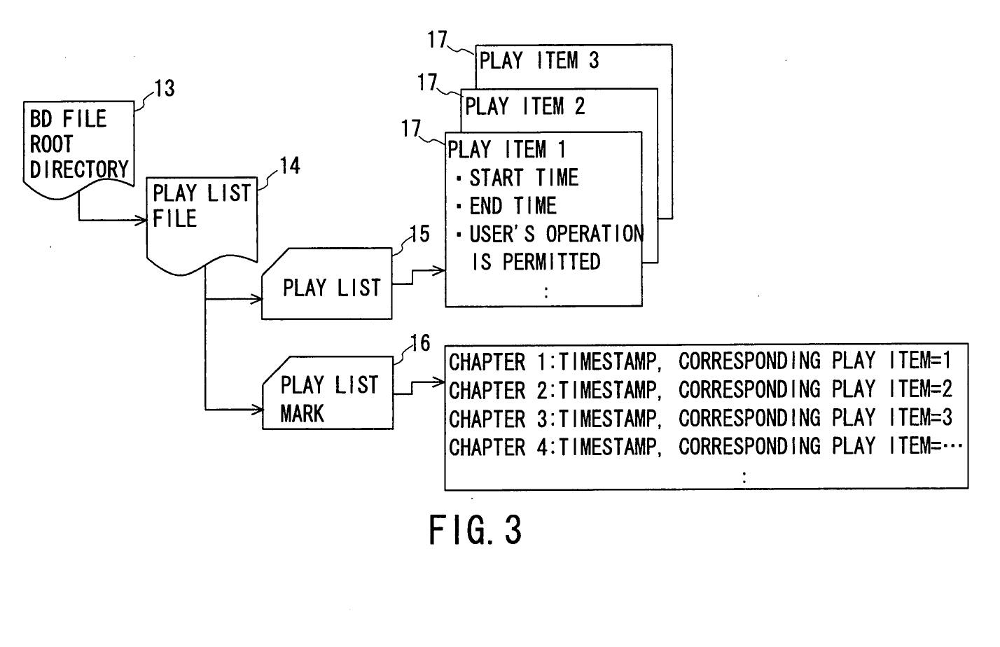

FIG. 3 is a diagram illustrating a structure of the file recorded on the Blu-ray Disc. On the Blu-ray Disc, as depicted in FIG. 3, the multiplicity of files is recorded so as to form (hierarchize) directories. The directories of the Blu-ray Disc are hierarchized so that a BD file root directory 13 ranks highest, and a play list file 14 is provided at a hierarchy lower by one than the BD file root directory 13. A play list 15 and a play list mark 16 are provided at the hierarchy lower by one than the play list file 14. The play list 15 consists of a multiplicity of play items 17. Further, the play list mark 16 defines a corresponding relation between the play items 17 and the chapters.

Each of the play items 17 defines reproduction control information such as permissibility of the user's operation and the chapter numbers of the chapters that should be played back at before-and-after stages in addition to start time and end time of the play item as the reproduction data of the content (The information on the permissibility of the user's operation corresponds to operation permissibility information according to the present invention. Further, the information on the chapter numbers of the chapters that should be played back at the before-and-after stages corresponds to reproduction sequence information according to the present invention). Moreover, each play list mark 16 defines a timestamp and a corresponding play item of a picture used for a thumbnail on a per-chapter basis.

<Whole Processing Flow>

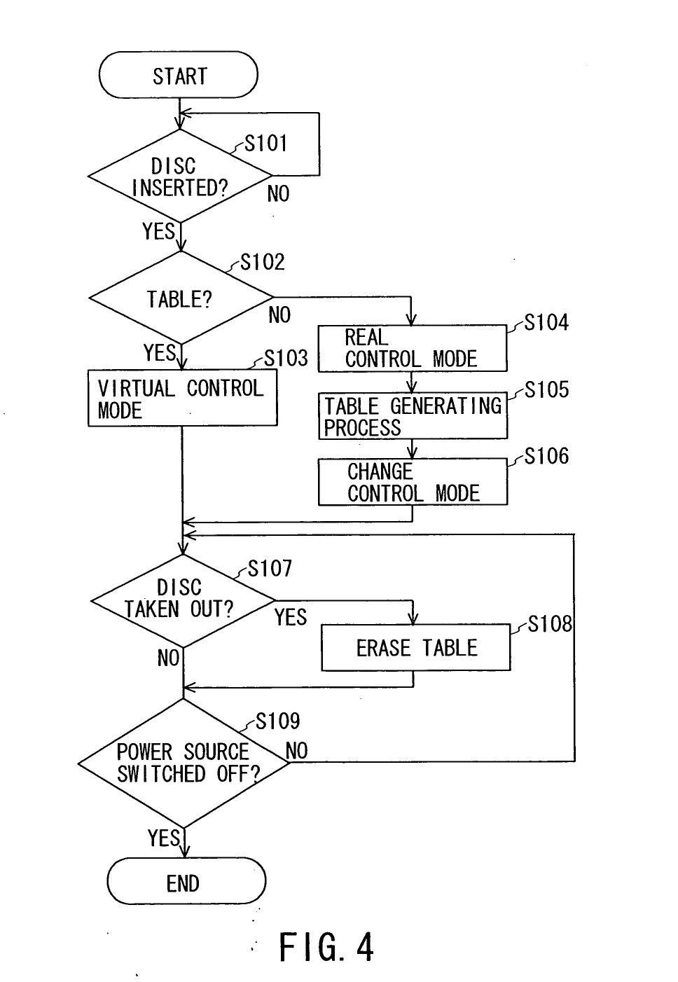

FIG. 4 is a flowchart illustrating a flow of the whole processes of the BD player 1. A rough operation flow of the BD player 1 will hereinafter be described with reference to the flowchart in FIG. 4.

When the BD player 1 is supplied with the electric power, the CPU 4 executes the computer program. Upon this execution, the CPU 4 realizes the variety of function units in cooperation with the various devices. When the start-up of the BD player 1 is completed, the table generating function unit 12 checks whether the Blu-ray Disc is inserted into the optical disc drive 6 or not (S101). If the Blu-ray Disc is not inserted, the operation involves waiting for a next process till inserted.

The table generating function unit 12, the Blu-ray Disc is inserted into the optical disc drive 6, refers to the memory 5 and thus checks whether the table is stored on the memory 5 or not (S102). The table generating function unit 12, after confirming that the table is stored on the memory 5, sets an operation mode of the operation processing function unit 10 to a virtual control mode (S103). Further, the table generating function unit 12, after confirming that the table is not stored on the memory 5, sets the operation mode of the operation processing function unit 10 to a real control mode (S104). Note that the case in which the table is stored on the memory 5 in the process instep S102 connotes a case in which, e.g., the table has been generated when the BD player 1 was started up last time and remains unerased from the memory 5.

Herein, the virtual control mode represents one control status of the operation processing function unit 10 and is specifically exemplified as follows. To be specific, the operation processing function unit 10, of which the control status is set to the virtual control mode by the table generating function unit 12, processes a variety of user's operations based on the table stored on the memory 5. For example, if the user conducts the operation of skipping the chapter with the operation button in the virtual control mode, the operation processing function unit 10, after referring to the table on the memory 5 and thus determining whether the skip operation can be done or not, executes the control of the optical disc drive 6 etc so as to actually access the disc.

Further, the real control mode represents one control status of the operation processing function unit 10, and is specifically exemplified as below. To be specific, the operation processing function unit 10, of which the control status is set to the real control mode by the table generating function unit 12, processes the variety of user's operations based on the reproduction control information of the play items 17 recorded on the Blu-ray Disc. For example, if the user performs the operation of skipping the chapter and the track with the operation button in the real control mode, the operation processing function unit 10 accesses the Blu-ray Disc by controlling the optical disc drive 6 and thus reads the reproduction control information such as the skip-destination chapter of the play item 17 corresponding to the user's operation. Then, the operation processing function unit 10 determines based on the readout reproduction control information whether the skipping operation can be done or not, and executes the operating process matching with a result of the determination. Subsequently, after the play item to be played back has been determined, the reproduction processing function unit 11 reproduces (plays back) the content corresponding thereto.

Note that in-depth descriptions of processing details of the virtual control mode and the real control mode will be made later on.

The table generating function unit 12, after setting the operation processing function unit 10 in the real control mode (S104), starts a table generating process (S105). To be specific, the table generating function unit 12, after the setting in the real control mode has been completed (S104), accesses the Blu-ray Disc by controlling the optical disc drive 6 irrespective of whether the user's operation has been done or not and sequentially reads the reproduction control information of the respective play items 17. Then, the operation processing function unit 10 generates the table on the basis of the readout reproduction control information and stores the table on the memory 5. Incidentally, the table generating process will be explained in detail later on. Note that the start of the table generating process (S105) is triggered by inserting the Blu-ray Disc into the BD player 1 and by switching ON the power source of the BD player 1 and may also, in addition, be triggered by pressing the playback button. Another scheme is that a new table generating switch is provided, and the start of the table generating process may be triggered by operating this switch.

The table generating function unit 12, upon a completion of the table generating process (S105), changes the operation processing function unit 10 to the virtual control mode (S106). Until the operation processing function unit 10 is changed to the virtual control mode, in other words, till the table generating process (S105) is completed, the operation processing function unit 10 remains set in the real control mode, and hence the access to the Blu-ray Disc is done each time the user's operation is performed with the operation button 8. After the operation processing function unit 10 has been set in the virtual control mode by executing the step (S106), however, the user's operation is processed based on the table stored on the memory 5.

When the user, who has finished viewing the content, performs the operation of taking the disc out (S107), the table generating function unit 12 erases the table stored on the memory 5 (S108). Further, if the power source is switched OFF by operating the key switch of the vehicle while conducting none of the operation of taking the disc out, the BD player 1 stops while the table remains stored on the memory 5.

The operation flow described above is the whole processing flow carried out till the BD player 1 is stopped since the start-up thereof. Next, the operation flow with some portions omitted in the discussion made above will be described in detail.

<Table Generating Flow>

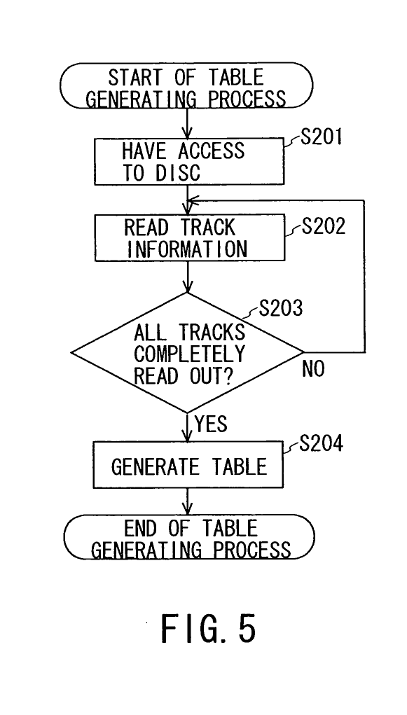

An in-depth description of the table generating process (S105) stated above will be given. FIG. 5 is a flowchart of the table generating process executed by the table generating function unit 12. The table generating process will hereinafter be described in conjunction with the flowchart in FIG. 5.

The table generating function unit 12, after setting the operation processing function unit 10 in the real control mode (S104), as depicted in FIG. 5, accesses the Blu-ray Disc by controlling the optical disc drive 6 (S201). The table generating function unit 12, after accessing the Blu-ray Disc, sequentially reads the reproduction control information of the play items 17 recorded on the disc (S202). The table generating function unit 12 continues this process till the completion of reading the reproduction control information with respect to all the play items 17 (S203). The table generating function unit 12, after the completion of reading the reproduction control information with respect to all the play items 17, generates the table based on the readout reproduction control information and stores the table on the memory 5 (S204).

The table generating function unit 12, upon the completion of the series of processes (S201-S204) generically defined as the table generating process (S105), changes the operation processing function unit 10 to the virtual control mode (S106). Theses processing are executed, whereby the reproduction control information of the Blu-ray Disc inserted into the optical disc drive 6 is stored on the memory 5 of the BD player 1.

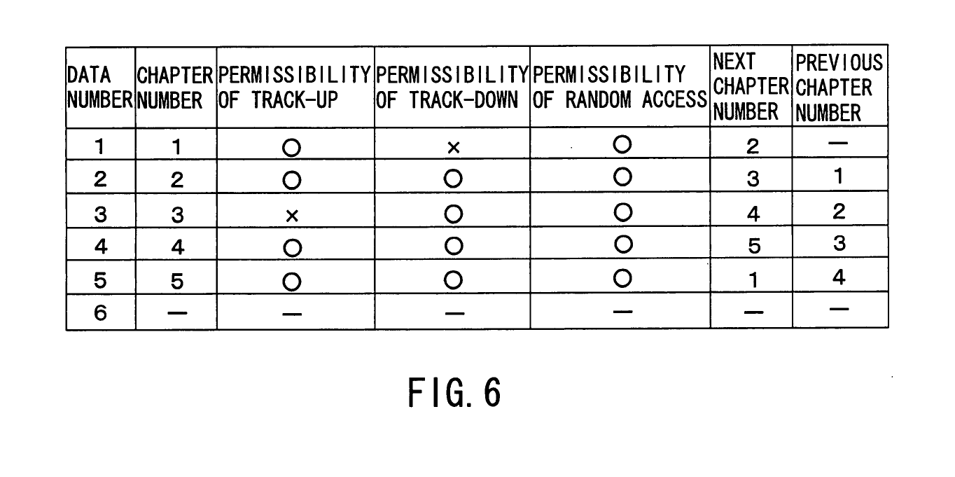

FIG. 6 is a diagram illustrating the table generated by the table generating function unit 12 and stored on the memory 5. The table generating function unit 12 tabularizes items of information such as a corresponding chapter number, track-up permissibility, track-down permissibility, random access permissibility, a should-be-next-played-back chapter number and a should-be-earlier-played-back chapter number, which are generically defined as the reproduction control information in each play item 17 as illustrated in FIG. 6, and stores this table on the memory 5.

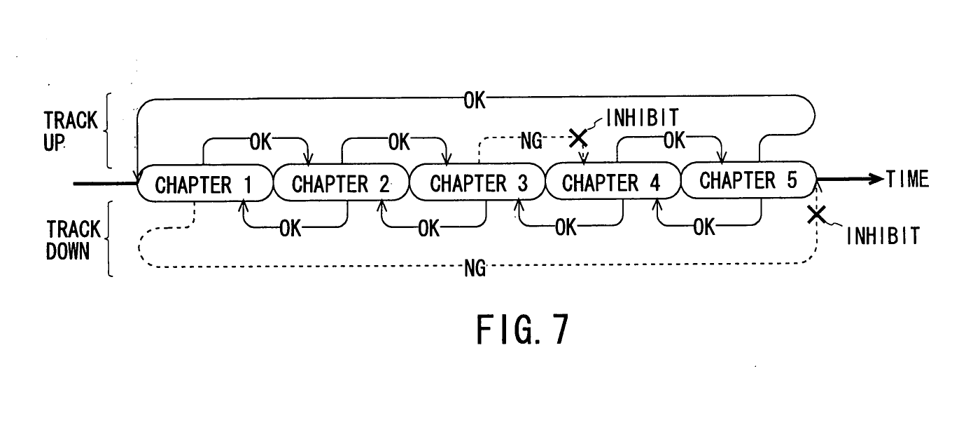

FIG. 7 is a diagram illustrating an operation pattern operable on the Blu-ray Disc for which the table generating function unit 12 generates the table. As depicted in FIG. 6, in the case of the Blu-ray Disc, a track-down operation or a track-up operation is inhibited in a chapter 1 and a chapter 3, however, other operations are permitted. Further, the chapter numbers of the chapters, which should be played back anteriorly and posteriorly, are defined in sequence. Hence, the Blu-ray Disc is played back sequentially up to the chapter 5 from the chapter 1. Moreover, the track-up operation is permitted in the chapters 1, 2, 4 and 5 but inhibited in the chapter 3. Further, the track-down operation is permitted in the chapters 2 through 5 but inhibited in the chapter 1.

<Processing Flow of Operation in Virtual Control Mode>

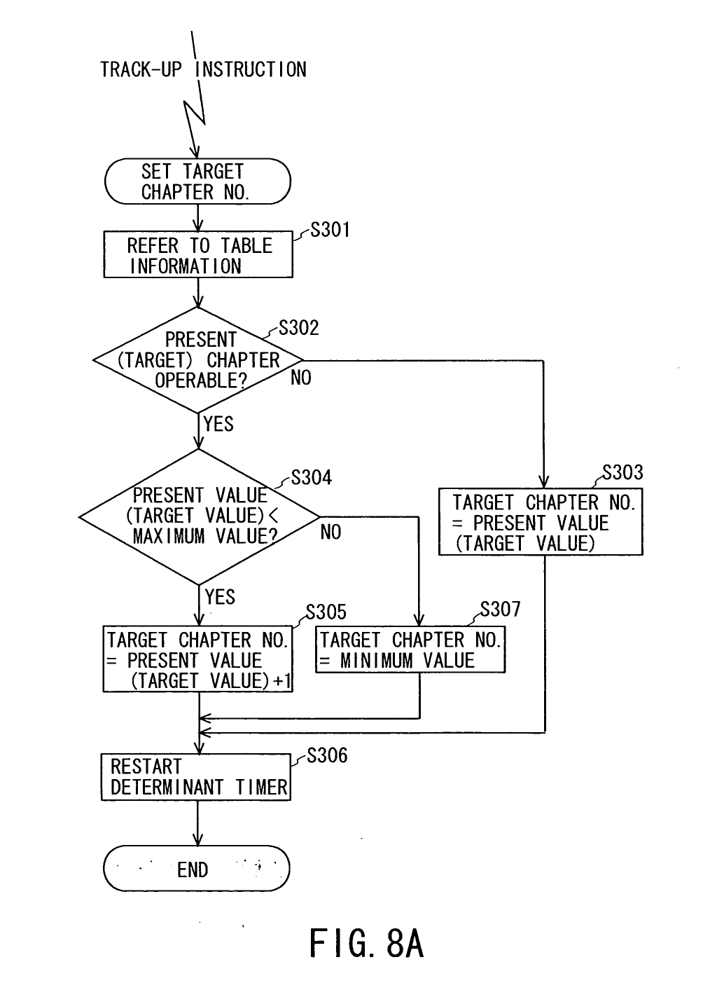

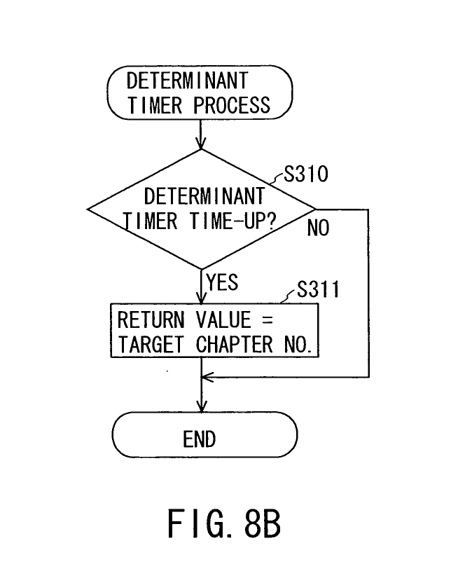

FIG. 8A is a flowchart illustrating one example of an operation process executed by the operation processing function unit 10 in the virtual control mode. The operation mode of the operation processing function unit 10 is set to the virtual control mode by the table generating function unit 12, and, the operation processing function unit 10 executes the following processes each time a track-up instruction is received from the user.

Namely, the operation processing function unit 10 kept in the status of the virtual control mode acquires, when the operation button 8 accepts the track-up operation from the user, the information in the table stored on the memory 5 (S301). Then, the operation processing function unit 10 checks whether or not the user's operation related to the track-up is permitted in the chapter that is now played back (S302). If the user's operation for the track-up is inhibited in the now-played-back chapter, the operation processing function unit 10, because of its being disabled from executing the track-up process, sets the now-played-back chapter to a target chapter number (S303) and diverts to step S306. Further, if the user's operation for the track-up is permitted in the now-played-back chapter, after confirming that the now-played-back chapter is not the last chapter (S304), “1” is added to a value of the now-played-back chapter number (S305). Then, the operation processing function unit 10 starts a determinant timer which measures, e.g., 500 ms (milliseconds) (S306). Further, if the now-played-back chapter is the last chapter, the operation processing function unit 10 sets the minimum value to a value of the target chapter number (S307) and starts the determinant timer (S306). Note that the process described above is a process in such a case that the first track-up instruction of starting the determinant timer from the stopping status is given. After the determinant timer has been operated in 5306, if the track-up instruction is again given in the middle of measuring 500 ms, the [present chapter] in S302 is replaced by the target chapter set in S305, S307 and S303, then the [present value] in S304, S305 and S303 is replaced by the target chapter number set in S305, 5307 and S303, and the processes in the respective steps are executed, thereby restarting the determinant timer in S306. Thereafter, the same processes are iterated each time the track-up instruction is given during the operation of the determinant timer.

FIG. 8B is a flowchart illustrating processes of the determinant timer and a flow of processes executed at an interval of predetermined time. At first, the operation processing function unit 10 determines whether or not the determinant timer completes the measurement of 500 ms (S310) and, if the determinant timer is in the non-operating status or is started in S306 and in the process of measuring 500 ms, terminates the process by executing nothing. If started in S306 or if the time elapses 500 ms since the restart, the operation processing function unit 10 determines the target chapter number set in S305, S307 and S303 as a final target value and sends this value as a return value back to the reproduction processing function unit 11 (S311).

In the operation processing flow in S301 through S307, the reproduction processing function unit 11, to which the target chapter number has been sent back as the return value, cancels the playback of the chapter that has been played back so far, then accesses the Blu-ray Disc via the optical disc drive 6, and starts playing back the chapter corresponding to this return value. Incidentally, the determinant timer described above is the timer for determining whether the user's consecutive operations are finished or not. If the user does not operate any button for a fixed period of time, the operation processing function unit 10 decides that the user completes the operation, and hands over the return value to the reproduction processing function unit 11. With this operation, the access to the disc is conducted. While on the other hand, if the user continues to operate the button, the operation processing function unit 10 decides that the user does not yet complete the operation of setting the target chapter number, and retains the return value without handing over this return value to the reproduction processing function unit 11. The access to the disc is thereby conducted in the middle of the user's performing the consecutive operations, resulting in eliminating a processing delay due to the operation of the hardware. Namely, an immediate response to the user's operation can be made. Further, whether the track-up operation is permitted or not is determined based on the pre-generated table of the memory 5, and the user's operation is processed, whereby it does not happen that the originally-inhibited user's operation is accepted and processed.

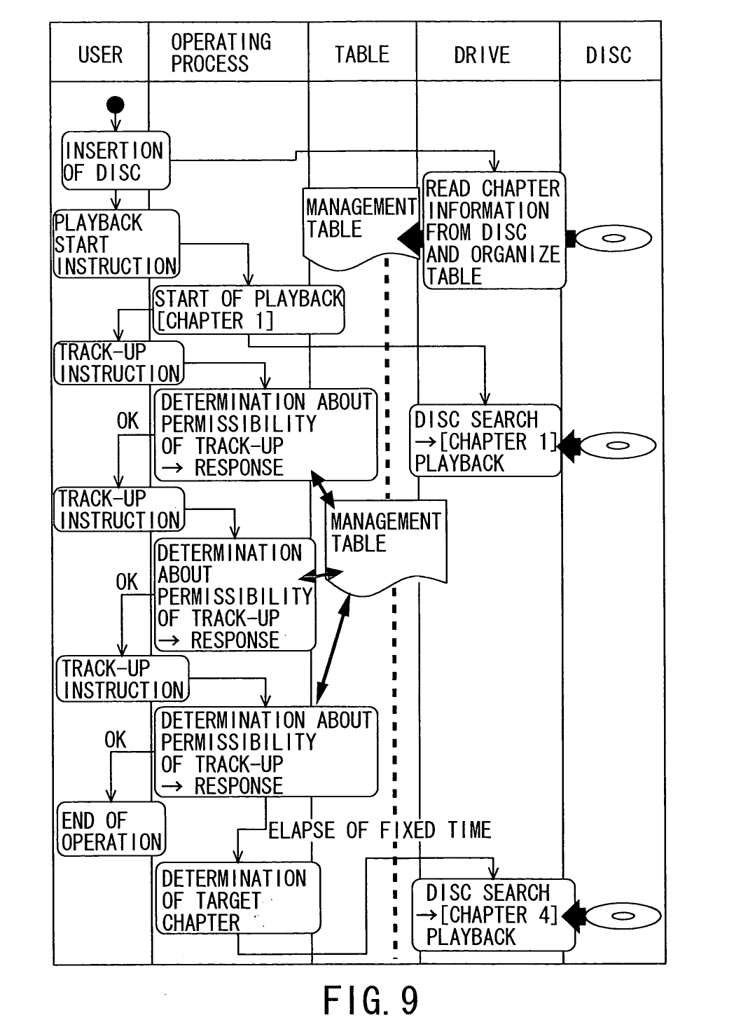

A flow of the operating process in the virtual control mode will be illustratively described. FIG. 9 is a diagram illustrating a processing flow in a case where the user performs the track-up operation three times consecutively in the virtual control mode. When the Blu-ray Disc is inserted into the BD player, the table generating function unit 12 starts generating the table. When the user carries out the playback operation in parallel with this operation, the BD player is played back sequentially from the chapter 1. Herein, in the status where the table generating function unit 12 completely generates the table (in other words, in the status of transitioning to the virtual control mode), the user performs the track-up operation three times consecutively, in which case the operation processing function unit 10 executes the following process. To be specific, upon accepting the track-up operation, the operation processing function unit 10 determines by referring to the table whether the track-up is permitted or not. Herein, an assumption is that the track-up operation is performed three times consecutively, and hence the operation processing function unit 10 refers to the table each time the track-up operation is done. Then, when confirming from the determinant timer that the fixed period of time has elapsed, the optical disc drive 6 accesses the Blu-ray Disc and reads a file of the chapter 4 that is the chapter to which the optical disc drive 6 skips over three tracks. Then, the reproduction processing function unit 11 reproduces (plays back) a content of the file of the chapter 4.

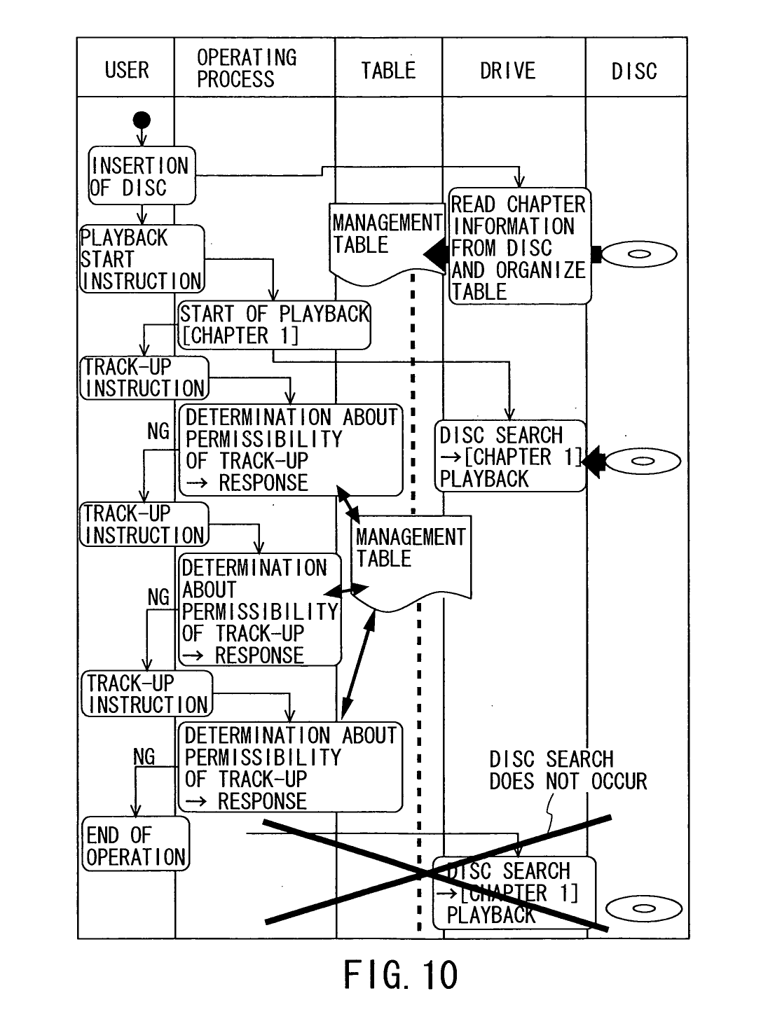

Herein, if the reproduction control information of the Blu-ray Disc inserted into the BD player 1 inhibits the track-up in the chapter 1 and if the table on the memory 5 is generated such as this, the operation processing function unit 10 in the virtual control mode executes the following process. FIG. 10 is a diagram illustrating a processing flow in a case where the user performs the inhibited track-up operation three times consecutively in the virtual control mode. When the track-up operation is conducted during the playback of the chapter 1, the operation processing function unit 10 refers to the table on the memory 5 and thus determines whether the track-up is permitted or not. Then, the operation processing function unit 10, as a result of the determination about the track-up permissibility, detects that the track-up operation is not permitted in the chapter 1. Herein, it is assumed that the track-up operation is carried out three times consecutively, and therefore the operation processing function unit 10 refers to the table for every track-up operation. The track-up operation is inhibited in the chapter 1, and hence the determination about the track-up permissibility is negative three times throughout. Resultantly, the track-up process is not executed, but the playback of the chapter 1 continues.

<Processing Flow of Operation in Real Control Mode>

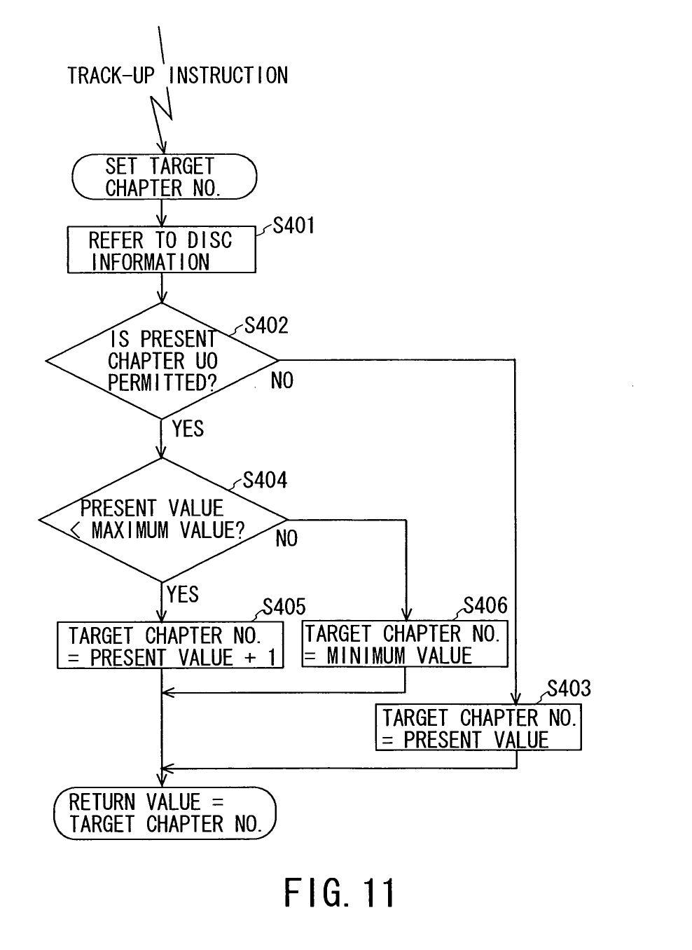

FIG. 11 is a flowchart illustrating one example of the operating process executed by the operation processing function unit 10 in the real control mode. The operation mode of the operation processing function unit 10 is set to the real control mode by the table generating function unit 12, and, the operation processing function unit 10, upon receiving the track-up operation from the user, executes the process given below.

Specifically, the operation processing function unit 10 in the real control mode, when the operation button 8 accepts the track-up operation from the user, refers to the play items 17 recorded on the Blu-ray Disc (S401). Then, the operation processing function unit 10 checks whether or not the user's operation related to the track-up is permitted in the now-played-back chapter (S402). If the user's operation for the track-up is inhibited in the now-played-back chapter, the operation processing function unit 10, because of its being disabled from executing the track-up process, sends back the now-played-back chapter number as the return value to the reproduction processing function unit 11 (S403). Further, if the user's operation for the track-up is permitted in the now-played-back chapter, after confirming that the now-played-back chapter is not the last chapter (S404), “1” is added to the value of the now-played-back chapter number (S405). Then, a result of the addition is sent back as a return value to the reproduction processing function unit 11. The track-up-based access to the disc is thereby immediately executed. Note that if the now-played-back chapter is the last chapter, the minimum value is set to the value of the target chapter number (S406), and this value is sent back as the return value to the reproduction processing function unit 11.

In the operation processing flow in S401 through S406, the reproduction processing function unit 11, to which the target chapter number has been sent back as the return value, cancels the playback of the chapter that has been played back so far, starts playing back a new chapter. In this process, immediately when accepting the user's operation, the access to the disc is executed. Hence, when the user consecutively performs the track-up operation, the process derived from the operation of the hardware is executed each time the track-up operation is carried out once. Accordingly, as compared with the case of the virtual control mode, the prompt response to the user's consecutive operations can not be made.

What has been discussed so far is the flow of the processes executed by the BD player 1. The scheme in the BD player 1 is not that the reproduction control information which can be arbitrarily set by the creator creating the content of the Blu-ray Disc is read by accessing the optical disc each time the user performs the operation but that all items of reproduction control information are previously retained as the table on the local memory. Then, the user's operation is processed based on the information in this table. Hence, the hardware-based access to the disc is not executed each time the user conducts the operation. It is therefore feasible to realize the quick process of the user's operation without being contrary to the reproduction control information set by the creator creating the content of the Blu-ray Disc.

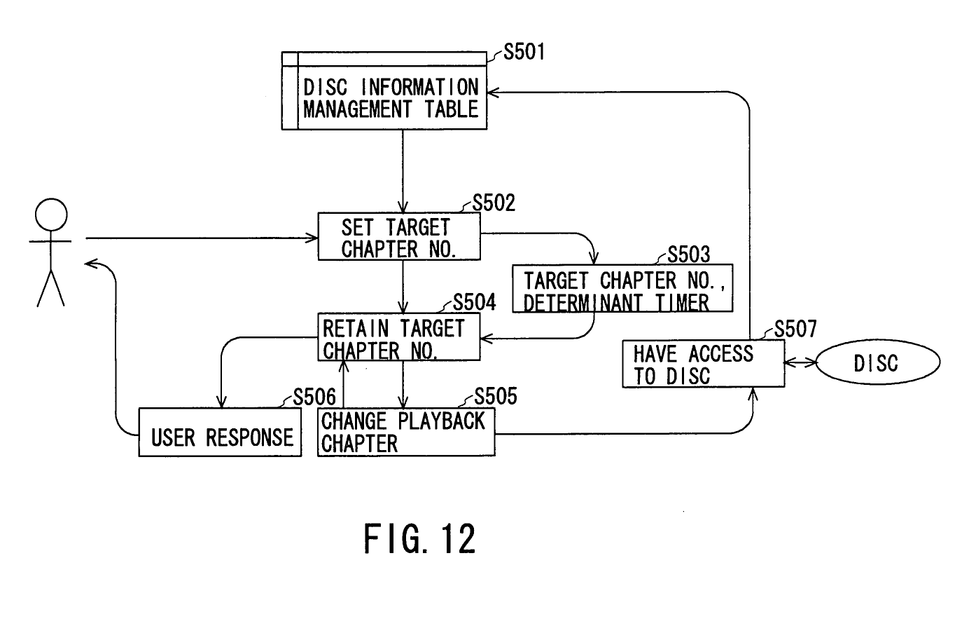

FIG. 12 is a diagram illustrating an outline of the processing flow realized by the BD player 1. As depicted in FIG. 12, the table is generated beforehand (S501), and, when the user performs the track-up operation to thereby set the target chapter number (S502), the target chapter number is retained (S504) till the fixed period of time elapses on the determinant timer (S503). Then, after confirming from the elapse time of the determinant timer that the fixed period of time has elapsed, there are executed the process of changing the chapter to be played back (S505) and the response process of the operation to the user (S506). The response process of the operation to the user is a process of notifying the user of a purport that the operation is properly processed, such as giving an operation responding tone and displaying the target chapter number on the display device 7. When starting the process of changing the chapter for the playback, the actual access to the disc is conducted, and the target chapter is played back (S507).

According to the BD player 1, in the case of reproducing the recording medium like the Blu-ray Disc stored with the multiplicity of content files, in which the reproduction control information such as forbidden items related to the reproducing sequence and the operation is arbitrarily set by the content creator, the user operability can be improved without being contrary to the items specified by the reproduction control information. Especially in the electronic devices over the recent years, a device actualizing the operation by executing the computer program has exhibited a rapid development, however, a delay of the processing time, which might cause an apprehension in this case, can be sufficiently avoided. Further, an on-vehicle electronic device is easier to be operated frequently than the electronic device used indoors, however, according to the BD player 1, a rapid response characteristic to the operation is enhanced. Note that the embodiment described above has discussed the track-up, however, the present invention can be, as a matter of course, applied to the track-down based on the same concept.

What is claimed is:

1. A content reproducing device reproducing a video/audio content recorded on a recording medium, comprising:
a reproduction processing unit accessing the recording medium and reproducing a plurality of content files stored with content reproducing data sequentially on the basis of a table indicating a content file reproducing sequence;
a table generating unit referring to a plurality of control information files prepared on a per-content-file basis within the recording medium and each having information, as reproduction sequence information, about the content file to be reproduced next to a self-corresponding content file, and thus generating the table from the reproduction sequence information of the respective control information files; and
an operation processing unit accepting a user's skipping operation over an in-reproduction content file,
wherein said operation processing unit, when accepting the skipping operation, determines the content file to be reproduced next from a relationship between the content file reproducing sequence indicated in the table generated by said table generating unit and the operation count of the skipping operation, and
said reproduction processing unit, when said operation processing unit determines the content file to be reproduced next, accesses the recording medium and reproduces the content file determined to be reproduced by said operation processing unit.

2. The content reproducing device according to claim 1, wherein said table generating unit tabularizes the reproducing sequence information given on the per-content-file basis and thus generates the table, and
said operation processing unit accepts the skipping operation conforming to the content file reproducing sequence information indicated in the table, and determines, as the content file to be reproduced next, the content file which is to be reproduced in the case of skipping by the operation count of the skipping operation.

3. The content reproducing device according to claim 1, wherein said operation processing unit, when accepting the skipping operation in the middle of generating the table by said table generating unit, accesses the recording medium and determines the content file to be reproduced next from the reproducing sequence information of the control information files.

4. The content reproducing device according to claim 1, wherein each control information file further contains, as operation permissibility information, on permissibility of the user's operation,
said table generating unit tabularizes the reproducing sequence information and the operation permissibility information on the per-content-file basis and thus generates the table, and
said operation processing unit, when accepting the skipping operation, determines the content file to be reproduced next on the basis of a relationship between the content file reproducing sequence indicated in the table generated by said table generating unit and the operation count of the skipping operation and on the basis of details of the operation permissibility of each content file.

5. The content reproducing device according to claim 1, wherein said table generating unit, upon a trigger of a predetermined user's operation performed before a start of reproducing the content, accesses the recording medium and generates the table from the reproducing sequence information of each control information file, and
the predetermined user's operation is at least any one of an operation of inserting the recording medium into said content reproducing device, an operation of reproducing the content recorded on the recording medium and an operation of switching ON a power source of said content reproducing device in an inserted status of the recording medium.
